(19) United States
(12) Patent Application Publication
(10) Pub. No.: US 2013/0262393 A1
(43) Pub. Date: Oct. 3, 2013

(54) Database backup without particularly specifying server

(71) Applicants: Matevz Mrak, Ljubljana (SI); Marko Ljubanovic, Ljubljana (SI); Ervin Adrovic, Holzgerlingen (DE)

(72) Inventors: Matevz Mrak, Ljubljana (SI); Marko Ljubanovic, Ljubljana (SI); Ervin Adrovic, Holzgerlingen (DE)

(21) Appl. No.: 13/436,692

(22) Filed: Mar. 30, 2012

(51) Int. Cl. G06F 17/30

(52) U.S. Cl. 707/659; 707/E17.01

(57) ABSTRACT

A backup policy specifies one or more given databases to be backed up. Servers dynamically host databases including the given databases. A given server from which each given database or a replica thereof is to be backed up is selected or chosen, by evaluating a predetermined backup strategy specified by the backup policy against a current state of the servers and the databases. The predetermined backup strategy governs how a given server is to be chosen from which each given database or a replica thereof is to be backed up. The backup policy does not particularly specify from which of the servers the given databases or replicas thereof are to be backed up. Each given database or a replica thereof is backed up from the given server selected or chosen for the given database.

### BACKGROUND

A database is an organized collection of information in digital form. In complex computing environments, such as those of enterprises, a large number of databases may be hosted on a large number of server computing devices, or servers. Different servers may host different databases at different times. A given database may have copies thereof hosted on different servers. The copies of a database are referred to as replicas. If a particular server hosting a given database goes offline, a different server hosting a replica of this database may become the new primary server for the database, to ensure that access to the information stored in the database can continue.

### BRIEF DESCRIPTION OF THE DRAWINGS

FIG. 1 is a diagram of an example system of a dynamic database hosting environment.

FIGS. 2A and 2B are diagrams depicting example dynamic database hosting environment scenarios in which the same backup policy can result in different servers being selected from which to back up a given database.

FIGS. 3A, 3B, and 3C are diagrams depicting performance of different example backup policies specifying different example backup strategies.

FIG. 4 is a flowchart of an example method.

### DETAILED DESCRIPTION

As noted in the background section, in complex computing environments, different servers may host different databases, including replicas thereof, at different times. Which server is primarily responsible for fielding access requests to a particular database may change over time, where other servers hosting replicas of this database may be ready to step in for the primary server if the primary server goes offline. As such, large-scale database hosting environments having large numbers of databases, including replicas thereof, and large numbers of servers are dynamic, and can be constantly changing depending on the current load, availability, and other factors of both the servers and the databases that they host.

Within these and other environments, it can still be important to back up databases and the information they contain to remote or other locations, apart from the replicas of the databases, which are instead primarily employed for load-balancing and failover considerations, among other factors. Typically, a backup approach specifies which copy of a database stored on which server is to be backed up to a remote or other location. At designated times, the designated database is backed up from the designated server.

However, this scenario imparts a management burden on the administrators responsible for ensuring that the complex computing environments in question operate seamlessly. An administrator may initially specify that a lesser-used replica of a database hosted on a given server be the source of the backup for this database, to ensure that the backup process does not cause performance degradation on access to the primary copy of the database hosted on a different server. As has been noted, though, database hosting environments are dynamic, and the considerations that may have originally led the administrator to select a particular replica of a database hosted on a given server may change over time.

For instance, the selected server may at some point in the future no longer host the selected replica of the database. The selected replica of the database may be thrust into a primary role if, for example, the primary copy of the database goes offline for whatever reason. In the former case, the backup process will fail, because the selected replica of the database can no longer be found on the selected server. In the latter case, the backup process can cause performance degradation, because the selected replica from which a backup of the database in question occurs is now the primary copy of the database that fields access requests to the information stored therein. As such, existing backup approaches for databases can mean that administrators have to constantly review and fine tune the selection of databases, including replicas thereof, and the selection of servers from which these databases are backed up.

Disclosed herein are techniques that permit databases hosted on servers to be backed up while avoiding these issues, so that administrators do not have to constantly review and fine tune which databases or replicas thereof are backed up from which servers, even in light of dynamic database hosting environments. A backup policy specifies one or more given databases to be backed up. The backup policy further specifies a predetermined backup strategy that governs how, for each given database, a given server is to be selected from which the given database or a replica thereof is to be backed up. However, the backup policy does not particularly specify (i.e., identify) from which of the servers the given databases or the replicas thereof are to be backed up.

When the time occurs to back up the given databases, a computing device evaluates the predetermined backup strategy against a current state of the servers and the databases. This current state can include which servers host which databases, including replicas thereof. The current state can further include the current load of the servers hosting the databases and their replicas. Properties of the databases and the servers can be collected as part of this evaluation, such as determining for a given database which copy is the primary copy currently fielding access requests to the information contained therein, determining for a given database which server hosting a copy of the database is the primary server, and so on.

As such, the computing device selects, for each given database, a given server from which the given database or a replica thereof is to be backed up, in accordance with the predetermined backup strategy. Each time database backup in accordance with the backup policy is initiated, different servers may be selected depending on the current state of the servers and the databases, even though the backup policy itself has not changed. An administrator thus may have to specify a backup policy just once, and not constantly fine tune the policy in light of dynamic changes to the database hosting environment. Rather, what changes is the selection of the servers from which the given databases specified by the backup policy are to be backed up, resulting from evaluation of the predetermined backup strategy of the backup policy against the current state of the databases and the servers that host them.

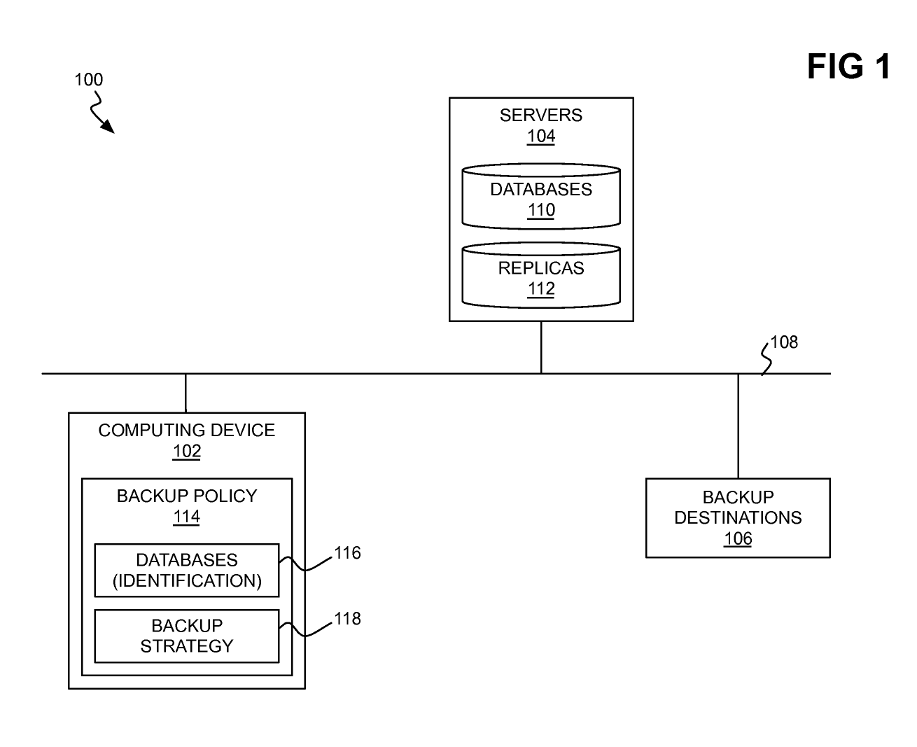

FIG. 1 shows an example system 100 that includes a computing device 102, a number of servers 104, and one or more backup destinations 106. The computing device 102 and the servers 104 are each a computing device like a desktop or laptop computer that includes hardware components such as processors, memory, storage devices, and so on. In some implementations, the computing device 102 may be one of the servers 104. For instance, in implementations in which the functionality described herein is performed by an agent, the computing device 102 on which the agent runs can be one of the servers 104. The backup destinations 106 may be local to or remote from the computing device 102 and/or the servers 104. The backup destinations 106 may themselves be computing devices, storage devices, or other types of destinations, such as storage-area networks (SANs).

The computing device 102, the servers 104, and the backup destinations 106 are communicatively interconnected to one another in one or more different ways. One example is a network 108. The network 108 may be or include the Internet, an intranet, an extranet, a wired network, a wireless network, a cellular network, a local-area network (LAN), a wide-area network (WAN), and so on. As another example, the communicative interconnection may be afforded by a direct connection apart from a network.

The servers 104 store databases 110 and replicas 112 thereof. Not all the databases 110 have replicas 112. Furthermore, for a given database 110, there may be more than one replica 112. A particular server 104 may host one or more of the databases 110 and/or one or more of the replicas 112 thereof. For fault tolerance purposes, typically at least one of the replicas 112 of a given database 110 is stored on a different server 104 than that which stores the primary copy of this database 110. That is, a particular database 110 (including its replica(s) 112) is stored on more than one of the servers 104. As discussed above, a replica 112 of a database 110 is a copy of the database 110. When a primary copy of a database 110 goes offline for whatever reason, the replica 112 thereof may step in to become the new primary copy of the database 110, so access to the information stored therein can continue.

As such, it is said that the servers 104 dynamically host the databases 110 and the replicas 112 thereof. This hosting is dynamic, at least in part because which of the servers 104 host which of the databases 110 and the replicas 112 thereof can change over time. The databases 110 and their replicas 112 can migrate among the servers 104, as load-balancing and other factors dictate, for instance. New replicas 112 of the databases 110 can be created, and existing replicas 112 can be deleted. New servers 104 can be brought online, and existing servers 104 can be taken offline. The database hosting environment is thus dynamic as to both the servers 104, as well as to the databases 110 and the replicas 112 thereof.

The computing device stores a backup policy 114 for one or more given databases 110. An administrator may initially specify the backup policy 114. The backup policy 114 provides a database designation or identification 116 of the given databases 110 that are to be backed up in accordance with the backup policy 114. The backup policy 114 further specifies a predetermined backup strategy 118 governing how for each given database 110 identified in the designation 116 one or more servers 104 hosting the given database 110 or replica(s) 112 thereof are to be selected from which the given database 110 is to be backed up.

However, the backup policy 114 does not itself particularly specify the servers 104 from which the given databases 110 or the replicas 112 thereof are to be backed up. That is, the backup policy 114 does not identify from which servers 104 the given databases 110 or their replicas 112 are to be backed up. Rather, the backup policy 114, via the backup strategy 118, specifies how these servers 104 are to be selected when it is time to perform a backup of the given databases 110 identified within the database designation 116 of the backup policy 114. The backup policy 114 does not, by comparison, a priori identify these servers 104.

For example, a given database 110 may be stored on a first server 104, and have a replica 112 that is stored on a second server 104. The backup policy 114 does not identify from which of these two servers 104 the given database 110 or its replica 112 is to be backed up, but rather specifies a backup strategy 118 that governs how which of these servers 104 is selected when a backup is performed. At the time of backup, then, either the first server 104 or the second server 104 may be selected. For instance, some times the first server 104 may be selected, whereas other times the second server 104 may be selected.

A schedule may govern when a backup in accordance with the backup policy 114 is to occur, or such a backup may be manually initiated by an administrator or other user. At that time, the computing device 102 selects for each given database 110 specified in the database designation 116 the server 104 from which the given database 110 or a replica 112 thereof is to be backed up. This is achieved by the computing device 102, which may be one of the servers 104 as noted above, evaluating the predetermined backup strategy 118 against the current state of the servers 104 and the database 110 and the replicas 112 that the servers 104 host. The computing device 102 can then initiate backup of the given databases 110 (or replicas 112 thereof) from the servers 104 most recently selected, by, for instance, having the servers 104 hosting the given databases 110 (or replicas 112 thereof) performing the backup themselves. The next time a backup is to occur, the servers 104 from which backup of the given databases 110 or replicas 112 thereof is to be performed are again reselected.

The backup policy 114 thus identifies given databases 110, via the database designation 116, which are to be backed up, and does not identify the specific servers 104 from which these databases 110 or their replicas are to be backed up. The designation of a given database 110 means the identification of one of the databases 110, including any replicas 112 of this database 110. Backing up the given database 110 means backing up either the primary copy of the database 110 itself, or one of the replica(s) 112 of this database 110. Thus, evaluation of the backup strategy 118 by the computing device 102 results in selection of which of these copies of the database 110 is to be backed up: either the primary copy of the database 110 itself, or a replica 112 of the database 110, if there are any such replicas 112.

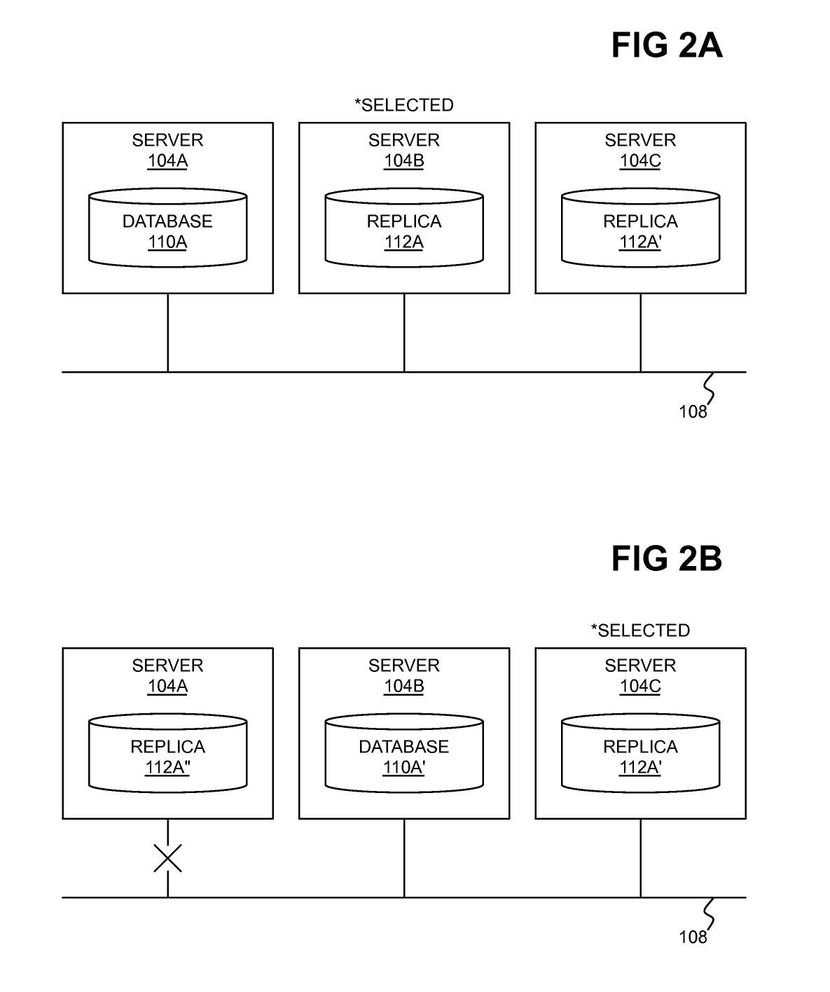

FIGS. 2A and 2B show different examples by which the predetermined backup strategy 118 of the backup policy 114 can be evaluated to result in different servers 104 being selected to back up a given database 110 or a replica 112 thereof even in light of the backup policy 114 not being modified and instead remaining the same. In FIG. 2A, a server 104A hosts a primary copy of a database 110A, whereas servers 104B and 104C host replicas 112A and 112A′, respectively, of the database 110A. The servers 104A, 104B, and 104C are connected to one another via the network 108. Evaluation of the backup strategy 118 is deemed to result in the server 104B being selected from which to back up the replica 112A of the database 110A.

Thereafter, in FIG. 2B, the connection between the server 104A and the network 108 goes down. The replica 112A hosted by the server 104B in FIG. 2A becomes the new primary copy of the database 110A, which is identified as the database 110A′ in FIG. 2B. Because the server 104A is no longer connected to the network 108, its prior primary copy of the database 110A automatically becomes a (stale) replica 112A″ of the new primary copy of the database 110A′. The replica 112A′ hosted by the server 104C remains a replica, but now of the new primary copy of the database 110A′. Although the backup strategy 118 of the backup policy 114 may not have changed, evaluation thereof is now deemed to result in the server 104C being selected form which to back up the replica 112A′ of the database 110A′.

FIGS. 2A and 2B thus show how evaluating the same backup policy 114 against different states of the database hosting environment results in the selection of different servers 104 from which to back up a given database 110 or a replica 112 thereof. In FIG. 2A, the server 104B hosting the replica 112A is selected, whereas in FIG. 2B, the server 104C hosting the replica 112A′ is selected. The backup policy 114 permits such different and dynamic selection, because the policy 114 does not particularly identify which server 104 from which a given database 110 or a replica 112 thereof is to be backed up. Rather, as noted above, the backup policy 114 specifies a backup strategy 118 that governs how such a server 104 is to be selected.

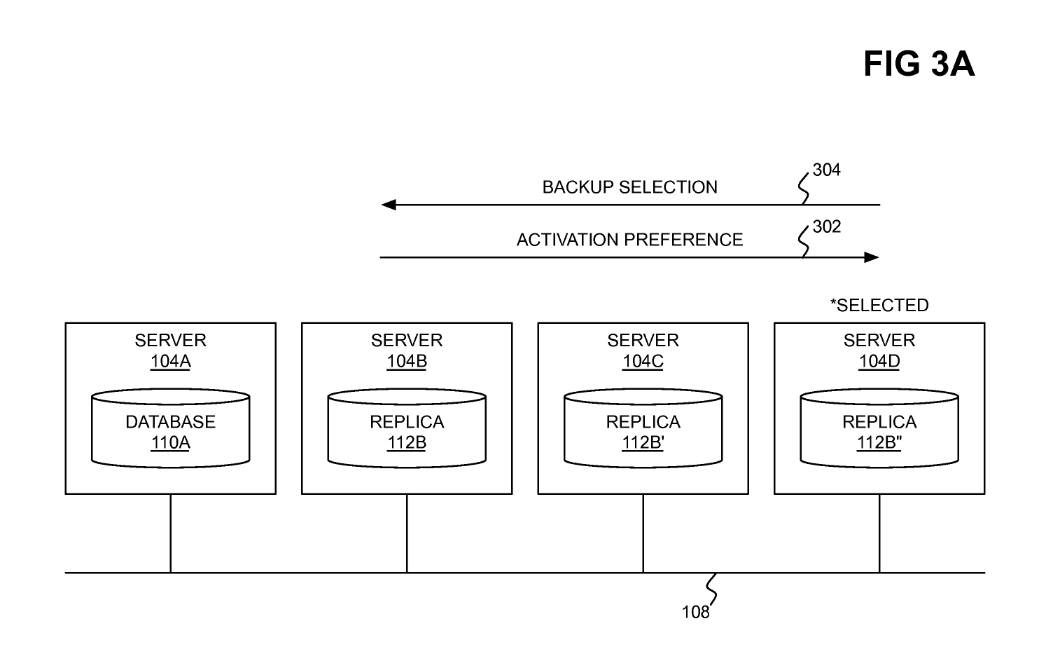

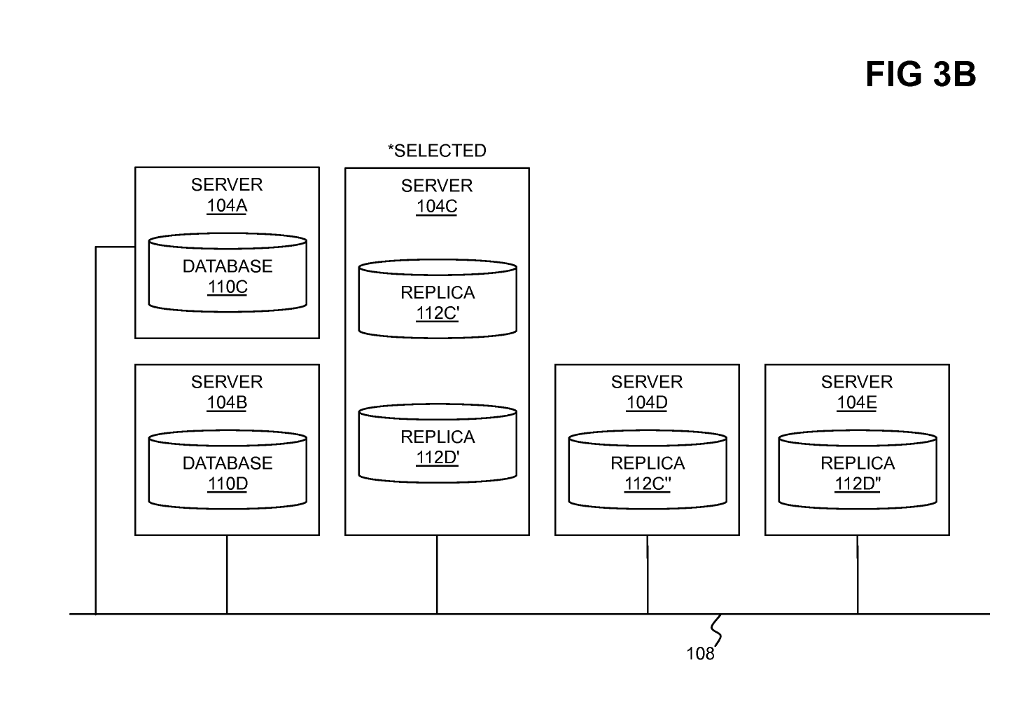

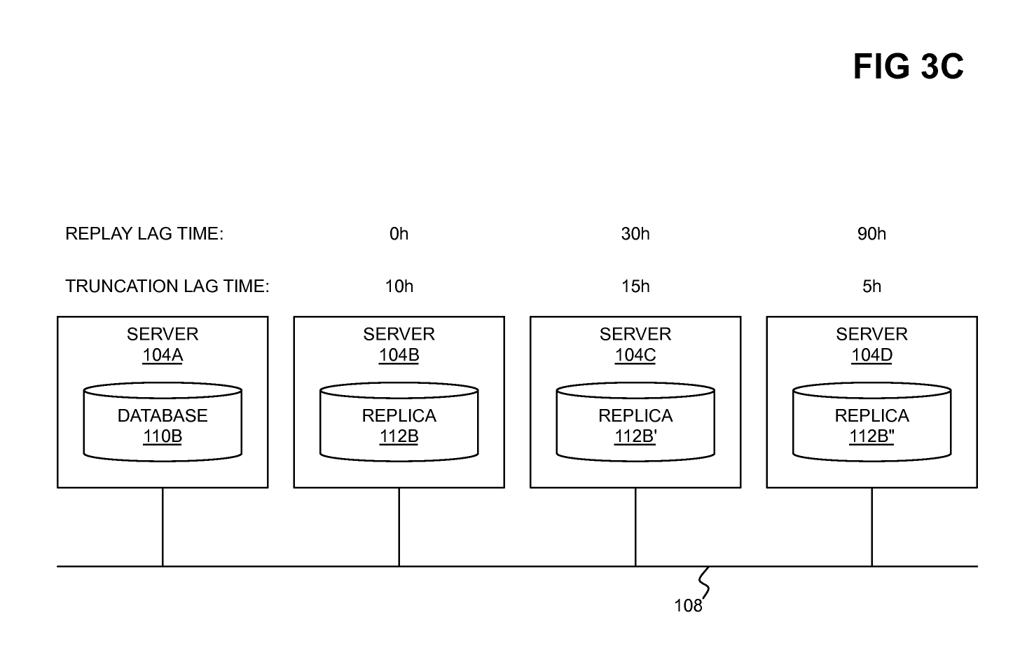

FIGS. 3A, 3B, and 3C show operation of different example backup strategies 118 in accordance with which the servers 104 from which the given databases 110 or their replicas 112 are to be backed up are selected. FIG. 3A demonstrates an example backup strategy 118 of the backup policy 114 focusing on activation preference. Servers 104A, 104B, 104C, and 104D are communicatively interconnected via the network 108, and host a database 110B and replicas 112B, 112B′, and 112B″ thereof, respectively.

The arrow 302 denotes the descending order of activation preference of the replicas 112B, 112B′, and 112B″ for taking over as the primary copy of the database 110B should the database 110B and/or the server 104A go offline. That is, the replica 112B is the first choice for taking over as the primary copy of the database 110B, the replica 112B′ is the second choice, and the replica 112B″ is the third choice. The backup strategy 118 of the backup policy 114 selects which server 104 from which to back up the database 110B or a replica 112B, 112B′, or 112B″ thereof in consideration of this activation preference.

Specifically, the backup strategy 118 of the backup policy 114 in the example of FIG. 3A chooses among the database 110B and the replicas 112B, 112B′, and 112B″ in the reverse order of activation preference, as indicated by the arrow 304. As such, the server 104D hosting the replica 112B″ is the first choice from which to back up the database 110B. Furthermore, the server 104C hosting the replica 112B′ is the second choice from which to back up the database 110B, and the server 104B hosting the replicating 112B is the third choice. That is, the server 104D hosting the replica 112B″ having the lowest activation preference is selected as that from which to back up the database 110B.

Considering activation preference when selecting which server 104 from which to back up a given database 110 or a replica 112 thereof minimizes the likelihood that the selected server 104 will be promoted from a standby state to an activate state during the backup process. For instance, if during backup the database 110B and/or the server 104A go offline, the replica 112B becomes the new primary copy of the database 110B and the server 104B becomes the new primary server. If the server 104B had been selected from which to backup a copy of the database 110B—i.e., the replica 112B—database performance may have degraded, because the replica 112B would both be primarily responsible for fielding access requests to the database 110B and also would be actively being backed up.

By comparison, selecting the server 104D hosting the replica 112B″ having the lowest activation preference, minimizes the likelihood that the replica 112B″ will be in the process of being backed up and the replica 112B″ called upon to take over as the primary copy of the database 110B. This is because during the backup process, all three of the database 110B hosted by the server 104A, the replica 112B hosted by the server 104B, and the replica 112B′ hosted by the server 104C would have to go offline before the replica 112B″ is called into active service and the server 104D made the new primary server in question. Considering activation preference within the backup policy 114 thus can ensure that performance degradation resulting from database backup is minimized.

FIG. 3B demonstrates a different example backup strategy 118 of the backup policy 114 focusing on minimizing the number of servers 104 from which to back up the given databases 110 or replicas 112 thereof. Servers 104A, 104B, 104C, 104D, and 104E are communicatively interconnected via the network 108. The servers 104A and 104B host different databases 110C and 110D, respectively. The server 104C hosts a replica 112C′ of the database 110C and a replica 112D′ of the database 110D. The servers 104D and 104E host a replica 1120″ of the database 110C and a replica 112D″ of the database 110D, respectively. The replicas 112C′ and 112D′ are higher in activation preference than the replicas 1120″ and 112D″.

In the example backup strategy 118 previously described with reference to FIG. 3A, the servers 104D and 104E would be selected from which to back up the replicas 1120″ and 112D″ of the databases 110C and 110D, because the replicas 1120″ and 112D″ have the lowest activation preference of their respective databases 110C and 110D. However, in FIG. 3B, the server 104C is selected from which to back up both the replicas 112C′ and 112D′ of the databases 110C and 110D. This is because the example backup strategy 118 in question focuses on minimizing the number of servers 104 from which to back up the given databases 110 or replicas 112 thereof; that is, the minimal number of servers 104 from which to backup the given databases 110 or replicas thereof are selected. Selecting the replicas 1120″ and 112D″ for backup results in selection of two servers 104D and 104E, whereas selecting the replicas 112C′ and 112D′ results in selection of one server 104C.

It is noted that in some implementations, a backup strategy 118 can be devised that takes into account activation preference while minimizing the number of servers 104 from which backup is to occur. For instance, in the example of FIG. 3B, assume that a single server 104A hosts both the databases 110C and 110D. To minimize the number of servers 104 from which backup is to occur, either this server 104A or the server 104C hosting the replicas 112C′ and 112D′ could be selected. Taking into account activation preference among these servers 104A and 104C, however, results in selection of the server 104C, since the server 104C hosts replicas 112C′ and 112D′, whereas the server 104A in this example hosts the primary copies of the databases 110C and 110D.

FIG. 3C demonstrates two additional example backup strategies 118 that focus on lag time of a replica in mirroring a database. In general, a replica mirrors a database as follows. As data is written to a database, the transactions (i.e., write or update requests) that result in such writing can be logged in a log file for each replica. At some point later in time, which is referred to as the replay lag time, the transactions are read from the log file and applied, or committed, to the replica in question. As such, a replica lags its corresponding database by the replay lag time; the replay lag time is depicted in FIG. 3C as being measured in hours, but can also be on the order of seconds, minutes, or even days or weeks. Furthermore, at a still later point in time, after a backup has been performed, and which is referred to as truncation lag time, the transactions are removed from the log file; that is, the corresponding log entries are removed from the log file. More specifically, the entire log file can be removed or deleted.

For example, assume that a replica of a database has a replay lag time of ten hours and a truncation lag time of fifteen hours. At time t=Oh data is written to the log file on the primary copy of the database and applied to this copy of the database, and a corresponding entry for this transaction added to the log file for the replica. At time t=10 h, the transaction is committed to the replica, such that the replica now mirrors the database at the state of the database at time t=0 h. At time t=25 h—fifteen hours later, which is equal to the truncation lag time—the entry for this transaction is removed to the log file for the replica.

In FIG. 3C, the servers 104A, 104B, 104C, and 104D are configured as in FIG. 3A, such that they host the database 1108 and the replicas 1128, 112B′, and 112B″ thereof, respectively. The servers 104A, 1048, 104C, and 104D are again communicatively interconnected via the network 108. The servers 1048, 104C, and 104D hosting the replicas 1128, 112B′, and 112B″ have replay lag times of zero hours, thirty hours, and ninety hours, respectively, and have truncation lag times of ten hours, fifteen hours, and five hours, respectively.

In an example backup strategy 118 focusing on replay lag time, the server 104 hosting the replica 112 having the lowest replay lag time may be selected from which a copy of the database 1108 is backed up, or in another example backup strategy 118, the server 104 hosting the replica 112 having the highest replay lag time may be selected. In the former case, the server 104B is selected, because the replica 1128 hosted by the server 1048 has the lowest lag time. As such, a backup of a copy of the database 1108—i.e., the replica 1128—that most closely mirrors (i.e., the most up-to-date copy of) the database 1108 in time is made. In the latter case, the server 104D is selected, because the replica 112B″ hosted by the server 104D has the highest lag time. As such, a backup of a copy of the database 1108—i.e., the replica 112B″—that most distantly mirrors (i.e., the least up-to-date copy of) the database 1108 in time is made.

Thus, an administrator can decide how closely a backup should mirror a copy of the database 1108 in time, and the server 104 hosting such a replica 112 is correspondingly selected. For instance, the backup can actually be a backup of a state of the database 1108 at a previous point in time. This means that the administrator can later restore the database to a state even before the backup itself has occurred, by, for example, applying changes at or related to a desired time of the backup instead of the backup in its entirety.

In an example backup strategy 118 focusing on truncation lag time, the server 104 having the replica 112 having the lowest truncation lag time may be selected from which a copy of the database 1108 is backed up, or in another example backup strategy 118, the server 104 hosting the replica 112 having the highest truncation lag time may be selected. In the former case, the server 104D is selected, because the replica 112B″ hosted by the server 104D has the lowest truncation lag time. In the latter case, the server 104C is selected, because the replica 112B′ hosted by the server 104C has the highest truncation lag time.

It is noted that a given backup strategy may not result in a particular copy of a database (such as a particular replica thereof) on a particular server being uniquely selected. Rather, application of the backup strategy may result in the identification of two or more such database copies and two or more of such servers. In such scenarios, the backup strategy described in relation to FIG. 3B may then be subsequently run to select a particular copy of the database in question from the copies identified, as hosted by a particular server from the servers identified. As described above, the backup strategy depicted in relation to FIG. 3B minimizes the number of servers from which backups are conducted, and thus can be usefully employed to provide to select just one database copy and just one server where the specified backup strategy would otherwise identify more than one copy and more than one server.

It is further noted that the backup strategies that have been described above are examples, and other backup strategies can be employed within backup policies, in addition to and/or in lieu of these backup strategies. One such backup strategy is to back up all copies (including all replicas) of a database. Another backup strategy is to back up the current active, or primary, copy of a database if no passive, or secondary, copies of the database are available. Furthermore, a server exclusion list may be specified as part of a backup policy, which identifies servers from which database copies are not to be made, and thus which should not be selected.

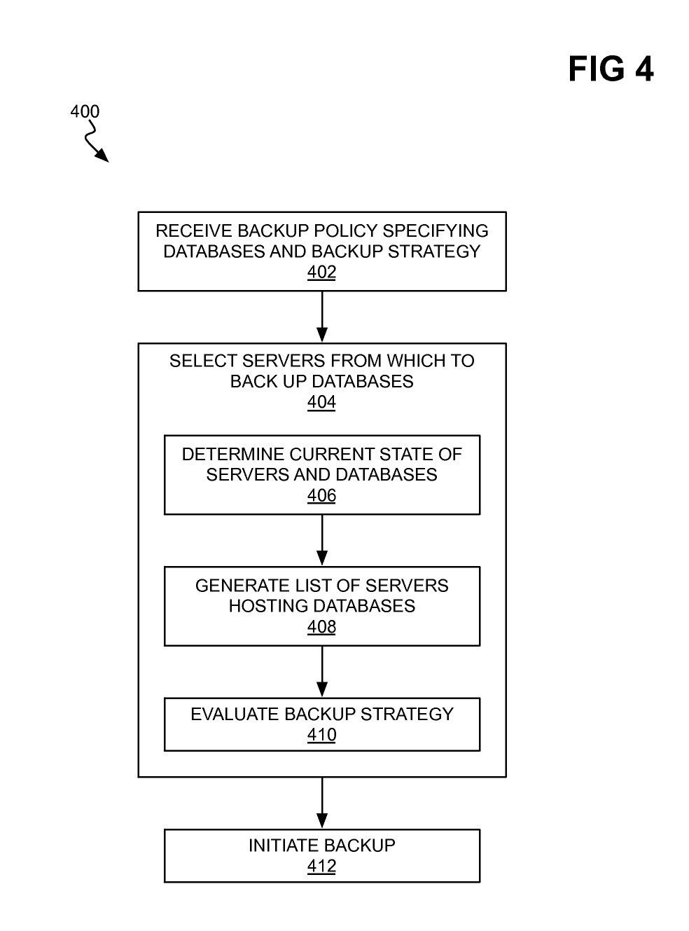

FIG. 4 shows an example method 400 to back up one or more given databases 110 in accordance with the techniques that have been described. The method 400 can be implemented as one or more computer programs stored on non-transitory computer-readable data storage medium. A processor of the computing device 102 can execute the computer programs to cause the method 400 to be performed.

The backup policy 114 is received (402), such as by retrieving the backup policy 114 from a storage device on which it has been stored. The backup policy 114 specifies a database designation 116 that identifies the given databases 110 to be backed up. The backup policy 114 also specifies a predetermined backup strategy 118 that governs how the servers 104 are to be selected from which the given databases 110 or the replicas 112 thereof are to be backed up.

The servers 104 from which the given databases 110, or their replicas 112, are to be backed up are thus selected or chosen in accordance with the backup policy 114 (404). This can be achieved as follows. The current state of the servers 104 and the databases 110 that they host—including the replicas 112 of the databases 110—is determined (406). The current state can include identifying which servers 104 are currently hosting which databases 110 and which replicas 112. The current state can also include the current load on the servers 104. Determining the current state can include collecting properties of each server 104, each database 110, and each replica 112, such as their activation preference, replay lag times, truncation lag times, and so on.

A list of the servers 104 is generated (408). The list indicates which databases 110 and/or which replicas 112 each server 104 is currently hosting. Thereafter, the backup strategy 118 is evaluated against this list of the servers 104, and thus against the current state of the servers 104 and the databases 110, including the replicas 112 thereof, to identify for each given database 110 of the database designation 116 the server 104 from which the database 110 (or a replica 112 thereof) is to be backed up. The backup of the given databases 110 is then initiated, or caused, from the servers 104 in question (412).

At least some parts of the method 400 can be repeated each time the given databases 110 are to be backed up, such as parts 404, 406, 408, 410, and/or 412. As noted above, because the servers 104 dynamically host the databases 110 and their replicas 112, the servers 104 selected in part 404 can change even though the backup policy 114 has not. That is, as the dynamic database hosting environment changes, different servers 104 may be selected from which to back up the same given databases 110 or their replicas.

We claim:

1. A method comprising:
receiving, by a computing device, a backup policy specifying one or more given databases to be backed up,
where a plurality of servers dynamically host a plurality of databases including the given databases, such that which of the servers host which of the databases are changeable over time, the databases including replicas thereof such that a particular database is hosted on more than one of the servers,
where the backup policy specifies a predetermined backup strategy governing how for each given database a given server of the servers is to be selected from which the given database or a replica thereof is to be backed up, the backup policy not particularly specifying from which of the servers the given databases or the replicas thereof are to be backed up;
selecting, by the computing device, for each given database, the given server of the servers from which the given database or a replica thereof is to be backed up, by evaluating the predetermined backup strategy of the backup policy against a current state of the servers and the databases at least as to which of the servers host which of the databases, including the replicas thereof; and
initiating, by the computing device, backup of each given database or a replica thereof from the given server selected for the given database.

2. The method of claim 1, wherein as the current state of the servers and the databases dynamically changes, different of the servers for the given databases are selected from which to back up the given databases or the replicas thereof without having to modify the backup policy, insofar as the backup policy does not particularly specify which of the servers the given databases or the replicas thereof are to be backed up from.

3. The method of claim 1, wherein the current state of the servers and the databases is further as to a current load of the servers hosting the databases, including the replicas thereof.

4. The method of claim 1, wherein selecting, for each given database, the given server from which the given database or a replica thereof is to be backed up is achieved further by:
determining the current state of the servers and the databases via collecting properties of each server and each database, including the replicas of the databases; and
generating a list of the servers, the list indicating which of the databases or the replicas thereof each server is currently hosting.

5. The method of claim 1, wherein the predetermined backup strategy specified by the backup policy is to minimize a number of the servers from which the given databases or the replicas thereof are backed up,
and wherein selecting, for each given database, the given server from which the given database or a replica thereof is to be backed up comprises selecting a minimal number of the servers on which all the given databases or the replicas thereof are currently hosted.

6. The method of claim 1, wherein the predetermined backup strategy specified by the backup policy is to select the servers from which the given databases or the replicas thereof are to be backed up such that activation preference of the servers on which the given databases or the replicas thereof are hosted is considered,
and wherein selecting, for each given database, the given server from which the given database or a replica thereof is to be backed up comprises selecting the given server having a lowest activation preference of the servers hosting the given database or a replica thereof,
such that during backup of each given database, a likelihood that the given server from which the given database is being backed up will be activated from a standby state to an active state is minimized.

7. The method of claim 1, wherein the predetermined backup strategy specified by the backup policy is to select the servers from which the given databases or the replicas thereof are to be backed up such that replay lag time of each given database or a replica thereof is considered,
wherein selecting, for each given database, the given server from which the given database or a replica thereof is to be backed up comprises selecting the given server hosting the given database or a replica thereof having a lowest replay lag time,
such that during backup of each given database, a most up-to-date copy of the given database is backed up due to the given server hosting the given database or a replica thereof having the lowest replay lag time being selected,
and wherein a replay lag time of a database specifies a length of time before transactions copied to a log file of the database are applied and committed to the database.

8. The method of claim 1, wherein the predetermined backup strategy specified by the backup policy is to select the servers from which the given databases or the replicas thereof are to be backed up such that replay lag time of each given database or a replica thereof is considered,
wherein selecting, for each given database, the given server from which the given database or a replica thereof is to be backed up comprises selecting the given server hosting the given database or a replica thereof having a highest replay lag time,
such that during backup of each given database, a least up-to-date copy of the given database is backed up due to the given server hosting the given database or a replica thereof having the highest replay lag time being selected,
and wherein a replay lag time of a database specifies a length of time before transactions copied to a log file of the database are applied and committed to the database.

9. The method of claim 1, wherein the predetermined backup strategy specified by the backup policy is to select the servers from which the given databases or the replicas thereof are to be backed up such that truncation lag time of each given database or a replica thereof is considered,
wherein selecting, for each given database, the given server from which the given database or a replica thereof is to be backed up comprises selecting the given server hosting the given database or a replica thereof having a lowest truncation lag time,
such that a likelihood of backup of each given database occurring most quickly is maximized due to the given server hosting the given database or a replica thereof having the lowest truncation lag time being selected,
and wherein a truncation lag time of a database specifies a length of time before transactions copied to a log file of the database are removed from the log file after the transactions have been applied and committed to the database.

10. The method of claim 1, wherein the predetermined backup strategy specified by the backup policy is to select the servers from which the given databases or the replicas thereof are to be backed up such that truncation lag time of each given database or a replica thereof is considered,
wherein selecting, for each given database, the given server from which the given database or a replica thereof is to be backed up comprises selecting the given server hosting the given database or a replica thereof having a highest truncation lag time,
such that a likelihood of backup of each given database occurring least quickly is maximized due to the given server hosting the given database or a replica thereof having the highest truncation lag time being selected,
and wherein a truncation lag time of a database specifies a length of time before transactions copied to a log file of the database are removed from the log file after the transactions have been applied and committed to the database.

11. A non-transitory computer-readable data storage medium storing a computer program executable by a processor of a computing device to perform a method comprising:
choosing, for each given database of one or more given databases to be backed up as specified by a backup policy, a given server of a plurality of servers dynamically hosting a plurality of databases including the given databases, the given database or a replica thereof to be backed up from the given server,
wherein choosing for each given database the given server comprises evaluating a predetermined backup strategy specified by the backup policy against a current state of the servers and the databases, the predetermined backup strategy governing how for each given database the given server is to be chosen from which the given database or a replica thereof is to be backed up, the backup policy not particularly specifying from which of the servers the given databases or replicas thereof are to be backed up; and
causing each given database or a replica thereof to be backed up from the given server chosen for the given database.

12. The non-transitory computer-readable data storage medium of claim 11, wherein the predetermined backup strategy specified by the backup policy comprises one or more of:
minimizing a number of the servers from which the given databases or the replicas thereof are backed up;
considering activation preferences of the servers on which the given databases or the replicas thereof are hosted;
considering replay lag time of each given database or a replica thereof;
considering truncation lag time of each given database or a replica thereof.

13. A system comprising:
a plurality of servers to dynamically host a plurality of databases, including replicas thereof; and
a computing device to select, for each given database of one or more given databases to be backed up as specified by a backup policy, a given server of the servers from which the given database or a replica thereof is to be backed up and is to cause the given database or a replica thereof to be backed up from the given server selected,
wherein the computing device is to evaluate a predetermined backup strategy specified by the backup policy and governing how for each given database the given server is to be selected from which the given database or a replica there is to be backed up,
and wherein the backup policy does not particularly specify from which of the servers the given databases or the replicas thereof are to be backed up.

14. The system of claim 13, wherein the predetermined backup strategy specified by the backup policy comprises one or more of:
minimizing a number of the servers from which the given databases or the replicas thereof are backed up;
considering activation preferences of the servers on which the given databases or the replicas thereof are hosted;
considering replay lag time of each given database or a replica thereof;
considering truncation lag time of each given database or a replica thereof.
